(19) United States
(12) Patent Application Publication
(10) Pub. No.: US 2023/0122942 A1
(43) Pub. Date: Apr. 20, 2023

(54) METHOD AND ARRANGEMENT FOR SIMULATING NEUROSURGICAL AND ORTHOPAEDIC SPINAL COLUMN AND CEREBRAL SURGERY

(71) Applicant: REALISTS TRAINING TECHNOLOGIES GMBH, Leipzig (DE)

(72) Inventor: Luis Enrique BERNAL VERA, Leipzig (DE)

(21) Appl. No.: 17/904,055

(22) PCT Filed: Feb. 12, 2021
(86) PCT No.: PCT/EP2021/053529

§ 371 Date: Aug. 11, 2022

(30) Foreign Application Priority Data
Feb. 14, 2020 (DE) 102020103997.2

(51) Int. Cl. G09B 23/30

(52) U.S. Cl. CPC G09B 23/303

(57) ABSTRACT

The invention relates to a method and an arrangement for simulating neurosurgical and orthopaedic spinal colunm and cerebral surgery, provided in which method are model structures which form anatomical structures and which are optically, haptically and functionally modelled on organs or organ parts to be surgically treated, by means of which model structures simulated surgical operations are carried out. The problem addressed by the invention is that of making surgery safer by further improving training, and therefore increasing patient safety. This is solved by the sensing of a parameter of the operation simulation, such as pressure, accuracy, tension, position and/or force, by a sensor and the parameter is assigned to and stored with the simulation event, which is outputted in a processed form on request.

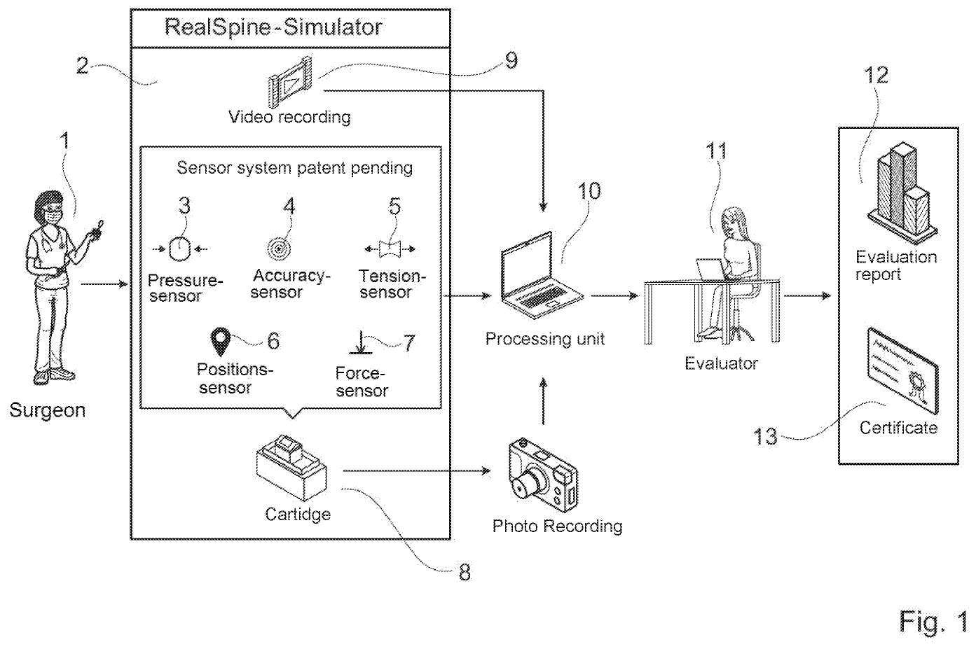

The invention relates to a method for simulating neurosurgical and orthopedic spinal column and cerebral surgery, wherein anatomical structure-forming model structures are provided, said model structures optically and haptically and functionally modeling organs or organ constituents to be treated by surgery and being used to carry out simulations of surgical operations.

The invention also relates to an arrangement for simulating neurosurgical and orthopedic spinal column and cerebral surgery, comprising model structures that form anatomical structures and that optically and haptically and functionally model organs or organ constituents to be treated by surgery.

The invention hence relates to training and simulation environments, in which surgeons can practice complex scenarios.

Internationally, surgical simulation and training has hitherto usually been carried out using simple plastics models or using virtual simulation (alternatively using human specimens).

The technology of the applicant which underlies this invention and which is known as the Real Spine training platform has stood out against all these technologies for many years. Using the applicant's technology, it was already possible to show that the simulation and training in surgery can be improved by means of 3D printing, modeling and artificial blood. However, it has hitherto not been possible to systematically measure, by way of sensors, the training performance of the participants in all desired scenarios.

The long-term goal is to increase the patient safety. In this case, it is the object of the invention to make surgery safer by further improving the training.

On the method side, the object is achieved by a method of the type set forth at the outset, in which according to the invention a parameter of the surgery simulation, such as pressure, accuracy, tension, position and/or strength, is registered by a sensor and stored assigned to the simulation result, which is output in prepared form upon request.

The basic concept of the invention lies in the integration of sensors in the modeled anatomy parts. To that end, use is moreover made of suitable measuring electronics and software.

To that end, provision is preferably made for the parameter to be registered by means of at least one of the model structures.

In a further embodiment, provision is made for the parameter to be stored together with a timestamp of its occurrence. Hence, it is always possible to assign the parameter to a time within the simulation.

Using such a “timestamp” in particular allows the parameter to be stored as a parameter sequence. Naturally, other parameters of the same or a different type can be stored in parallel as time-related individual values or likewise as parameter sequences. Consequently, following a preparation of the values, the parameter situation at certain surgery simulation times can be reconstructed whenever required.

In a further embodiment of the invention, provision is made for at least one of the parameters to be registered by way of an optical recording. It is possible in some situations to deduce a parameter purely from an image or a video sequence. By way of example, if a deformation of an anatomical structure in the case of an applied instrument can be registered in an image, the exerted compressive force can be deduced from the optically visible size and type of deformation.

In a further variant, provision is made for one of the sensors to be provided in modeled neural structures or connected to modeled neural structures.

In a further embodiment of the method according to the invention, provision is made for one of the sensors to be provided in muscular structures, ligaments and/or fascias or connected to muscular structures, ligaments and/or fascias, and for a parameter to be determined to measure complications and bleeding, coagulation and hemostasis.

The arrangement-side solution to the problem in the case of an arrangement of the type set forth at the outset consists in sensors that at least indirectly register parameters of the operation simulation being connected to the model structures and said sensors in turn being connected to a processing unit that registers, stores and evaluates the parameters.

In an embodiment in this respect, provision is made for the model structures to consist of plastics composites and simultaneously form the sensors. It is also possible for the model structures to consist of intelligent materials and simultaneously form the sensors.

This is achieved by way of integrated special sensors which do not change the anatomy, haptics and optics of the intervention. The seamlessly integrated sensor system renders it possible for the first time ever to evaluate the training, with the haptics and the optics nevertheless remaining very realistic in the process.

Modeling and scientific validation are tightly linked and occur in close collaboration with clinical partners (=clinical validation).

To this end, the invention provides for the first time a development of sensors that integrate seamlessly into the model structures of the simulators and at the same time meet the very stringent haptic and optical requirements that are expected of surgical simulators. Hitherto, such sensors have not been commercially available.

In this respect, it is possible according to the invention for at least one of the sensors to be arranged in modeled neural structures or connected thereto.

Another option consists in at least one of the sensors being arranged in modeled muscular structures, ligaments and/or fascias or connected thereto.

It is also possible for at least one of the sensors to be designed to measure complications and/or bleeding, coagulation and/or hemostasis.

The solution according to the invention is presented below on the basis of an exemplary embodiment.

The associated drawing shows an overview of the arrangement according to the invention and the method according to the invention in conjunction with a further non-technical evaluation.

Surgeons would like to train in ever more complex and ever more realistic simulation environments (which were hitherto inconceivable) and, in so doing, compare their own performance to that of other surgeons (especially the experts). This requires the integrated measuring systems according to the invention.

The great complexity of the sensor system and the instrument/tissue interaction could not hitherto be achieved by any group worldwide. This innovation is rendered possible by the experience the inventors have in relation to the materials and material properties in surgery simulation and the required technologies, for example coating, generative methods, processing of additives and technical textiles, etc.

As depicted in the drawing, a training surgeon (trainee) 1 operates on the RealSpine simulator 2. In the process, their surgical actions are registered in various parameters such as pressure 3, accuracy 4, tension 5, position 6 and/or strength 7 by way of the above-described special sensors. In this case, use can be made of a direct registration, an optical recording (photographic record) 8 or a video recording 9. All these results are then stored together (results report) in a processing unit 10, and can be prepared and output. This completes the present technical invention.

The invention provides an assessor (certified evaluator) 11 with technical means to allow said person to assess the simulated surgical action and ultimately create an assessment report 12, and optionally create a certificate 13 relating to the capabilities of the surgeon.

### LIST OF REFERENCE SIGNS

1 Surgeon (trainee)
2 Real Spine simulator
3 Pressure sensor
4 Accuracy sensor
5 Tension sensor
6 Position sensor
7 Strength sensor
8 Image recording
9 Video recording
10 Processing unit
11 Assessor
12 Assessment report
13 Certificate

1. A method for simulating neurosurgical and orthopedic spinal column and cerebral surgery, wherein anatomical structure-forming model structures are provided, said model structures optically and haptically and functionally modeling organs or organ constituents to be treated by surgery and being used to carry out simulations of surgical operations, comprising: registering a parameter of the surgery simulation, such as pressure, accuracy, tension, position and/or strength by at least one sensor storing the assigned parameter to a simulation result; and outputting the simulations result in prepared form upon request.

2. The method as claimed in claim 1, wherein the parameter is registered by at least one of the model structures.

3. The method as claimed in claim 1, wherein the parameter is stored together with a timestamp of its occurrence.

4. The method as claimed in claim 3, wherein the parameter is stored as a parameter sequence.

5. The method as claimed in claim 1, wherein at least one of the parameters is registered by way of an optical recording.

6. The method as claimed in claim 1, wherein one of the sensors is provided in modeled neural structures or connected to modeled neural structures.

7. The method as claimed in claim 1, wherein one of the sensors is provided in muscular structures, ligaments and/or fascias or connected to muscular structures, ligaments and/or fascias, and a parameter is determined to measure complications and bleeding, coagulation and hemostasis.

8. A system for simulating neurosurgical and orthopedic spinal column and cerebral surgery, comprising model structures that form anatomical structures and that optically and haptically and functionally model organs or organ constituents to be treated by surgery, for carrying out the method as claimed in claim 1, wherein sensors that at least indirectly register parameters of the operation simulation are connected to the model structures and said sensors are in turn connected to a processing unit that registers, stores and evaluates the parameters.

9. The system as claimed in claim 8, wherein the model structures consist of plastics composites and simultaneously form the sensors.

10. The system as claimed in claim 8, wherein the model structures consist of intelligent materials and simultaneously form the sensors.

11. The system as claimed in claim 8, wherein at least one of the sensors is arranged in modeled neural structures or connected thereto.

12. The system as claimed in claim 8, wherein at least one of the sensors is arranged in modeled muscular structures, ligaments and/or fascias or connected thereto.

13. The system as claimed in claim 8, wherein at least one of the sensors is designed to measure complications and/or bleeding, coagulation and/or hemostasis.

14. The method as claimed in claim 2, wherein the parameter is stored together with a timestamp of its occurrence.

15. The method as claimed in claim 14, wherein at least one of the parameters is registered by way of an optical recording.

16. The method as claimed in claim 14, wherein one of the sensors is provided in modeled neural structures or connected to modeled neural structures.

17. The method as claimed in claim 14, wherein one of the sensors is provided in muscular structures, ligaments and/or fascias or connected to muscular structures, ligaments and/or fascias, and a parameter is determined to measure complications and bleeding, coagulation and hemostasis.

18. The method as claimed in claim 3, wherein at least one of the parameters is registered by way of an optical recording.

19. The method of claim 1 wherein the at least one sensor is connected to the model structure and to a processing unit.
